(19) United States
(12) Patent Application Publication
(10) Pub. No.: US 2017/0259747 A1
(43) Pub. Date: Sep. 14, 2017

(54) ORGANIZER ASSEMBLY

(71) Applicant: Jerry Wilbern FORBES, Corydon, IN (US)

(72) Inventor: Jerry Wilbern FORBES, Corydon, IN (US)

(21) Appl. No.: 15/065,413

(22) Filed: Mar. 9, 2016

(51) Int. Cl. B60R 7/02

(52) U.S. Cl. CPC B60R 7/02

(57) ABSTRACT

An organizer assembly having interconnecting slotted partitions for segregating and organizing vehicular space for securing a plurality of containers therein is provided. The partitions or dividers provide a plurality of evenly spaced apart securing slots along their top edge, each securing slots having a lead-in notch for securing a container. In certain embodiments, the dividers are connected to a base with pivotal supporting elements. In other embodiments, the dividers provide assembly slots for arranging two intersecting dividers into X-shaped configurations. In yet another embodiment, a body divider and wing divider are pivotally connected to form a V-shape configuration, each of which can be sequentially attached to other such configurations by mating connections at the ends of the body dividers.

### BACKGROUND OF THE INVENTION

The present invention relates to space organizers and, more particularly, to an organizer assembly having interconnecting slotted partitions for segregating and organizing vehicular space for securing a plurality of containers therein.

Grocery items in the trunk of your car, van, pick-up or other vehicles often spill out of the grocery bags, crushing and breaking their contents, such as fruits, eggs, and bread, or the contents of a neighboring bag, Also, often tall objects such as gas cans, tip over causing spillage. Then when you return home, you have to re-bag the items, and clean up any spillage.

Current grocery bag organizers come in two types: the first having hooks that you hang grocery bags from, or the second having soft unfolding panel, neither of which work very well with heavy items, such as milk jugs, two liter bottles, can goods, tall gas cans, and the like, because the grocery bags either end up swinging wildly from the hooks or tear away from the soft panels.

As can be seen, there is a need for an organizer assembly having interconnecting slotted partitions for segregating and organizing vehicular space for securing a plurality of containers therein, keeping heavy items from crushing fragile items, and efficiently utilizing the vehicular space, especially on a winding drive home.

### SUMMARY OF THE INVENTION

In one aspect of the present invention, an organizer assembly having interconnecting slotted partitions for segregating and organizing vehicular space for securing a plurality of containers therein includes a first planar divider defined by a first top edge and an opposing first bottom edge; a plurality of first securing slots provided along the first top edge, wherein each first securing slot terminates between the first top edge and the first bottom edge; and wherein each of the plurality of first securing slots provides a lead-in notch communicating to the first top edge.

In another aspect of the present invention, the organizer assembly further includes a second planar divider defined by a second top edge and an opposing second bottom edge; and a pivotal connection pivotally connecting a second end of the second planar divider near a first end of the first planar divider.

In yet another alternative aspect of the present invention, the organizer assembly further includes a first assembly slot formed perpendicular to the first bottom edge; a second planar divider defined by a second top edge and an opposing second bottom edge; and a second assembly slot formed perpendicular to the second top edge, wherein the first and second assembly slots are dimensioned and adapted to engage so that both the first and second bottom edges are approximately coplanar.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a top plan view of an exemplary embodiment of the present invention;

FIG. 3 is an exploded perspective view of an exemplary embodiment of the present invention;

FIG. 4 is a perspective view of an exemplary embodiment of the present invention, demonstrating a collapsed configuration;

FIG. 5 is an exploded perspective view of an exemplary embodiment of the present invention;

FIG. 6 is a top view of an exemplary embodiment of the present invention;

FIG. 7 is a perspective view of an exemplary embodiment of the present invention, demonstrating an expanded configuration;

FIG. 8 is a detail top plan view of an exemplary embodiment of the present invention, indicated by the line 8-8 of FIG. 6;

FIG. 9 is a perspective view of an exemplary embodiment of the present invention, illustrating support elements in a folded configuration; and

FIG. 10 is a perspective view of an exemplary embodiment of the present invention, illustrating the support elements in an unfolded configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an organizer assembly having interconnecting slotted partitions for segregating and organizing vehicular space for securing a plurality of containers therein. The partitions or dividers provide a plurality of evenly spaced apart securing slots along their top edge, each securing slots having a lead-in notch for securing a container. In certain embodiments, the dividers are connected to a base with pivotable supporting elements. In other embodiments, the dividers provide assembly slots for arranging two intersecting dividers into X-shaped configurations. In yet another embodiment, a body divider and wing divider are pivotally connected to form a V-shape configuration, each of which can be sequentially attached to other such configurations by mating connections at the ends of the body dividers.

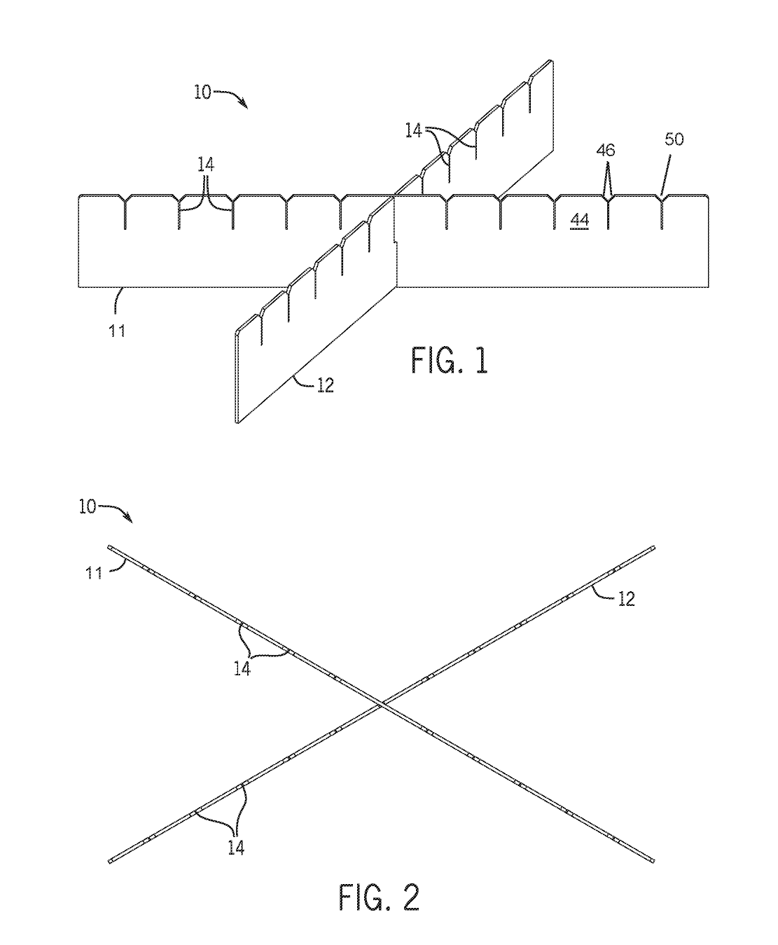

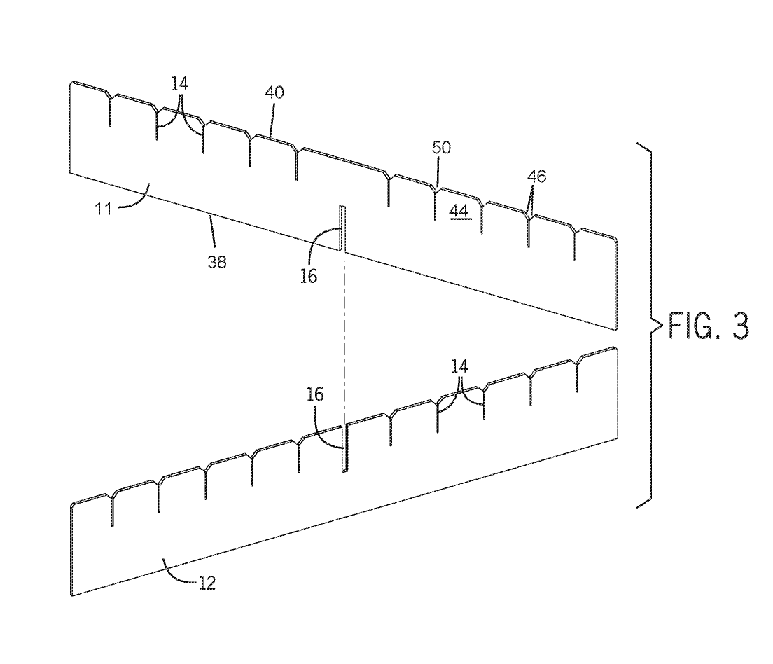

Referring to FIGS. 1 through 10, the present invention may include an organizer assembly 10, 20, 30 having interconnecting slotted partitions for segregating and organizing vehicular space for securing a plurality of containers therein.

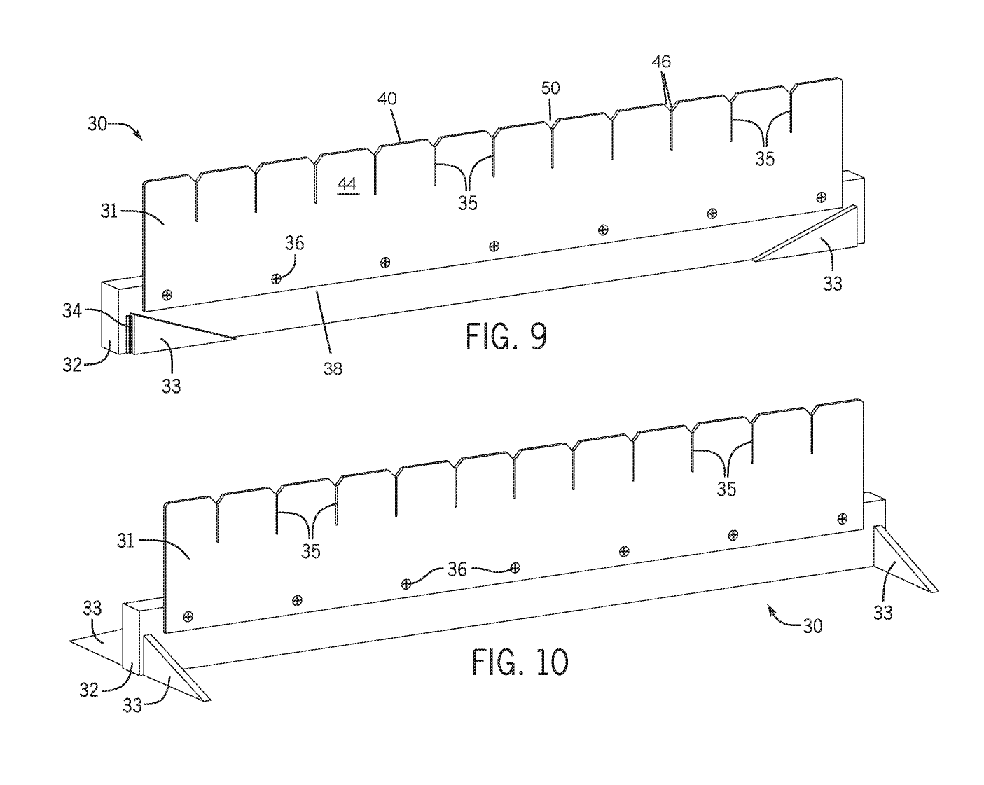

Referring to FIGS. 9 and 10, the organizer assembly may include an elongated divider 31 defined by a bottom edge 38 and a top edge 40. The elongated divider 31 may have a plurality of spaced apart securing slots 35, 23, 14 extending from the top edge 40 of the elongated divider downwardly to approximately a centerline of the divider 31, thereby defining a plurality of tabs 44 between each pair of adjacent securing slots 35, 23, 14. Each securing slot 35, 23, 14 may provide lead-in notches 50 along the top edge 40, defined by two mirrored diagonal cut lines 46, giving the tabs 44 a cut corners.

The elongated divider 31 may be attached to an elongated base 32 by a plurality of fasteners 36 along the bottom edge 38 of the divider 31. The elongated base may provide a plurality of support elements 33 that are pivotally attached to opposing ends of the elongated base 32 by pivotal connectors 34. As a result, the support elements 33 may be movable from a folded configuration to an unfolded configuration stabilizing the elongated base 32 and thus the divider 31 on a supporting surface 60. In effect, defining a stand-alone organizer assembly 30, as illustrated in FIGS. 9 and 10.

Referring to FIGS. 1 through 3, the organizer assembly may include a first divider 11 and a second divider 12, wherein the first divider 11 provides a first assembly slot 15 extending from near a midpoint of the bottom edge 38 of the first divider 11 upwardly to approximately the centerline of the first divider 11. In certain embodiments, the two securing slots 14 straddling the first assembly slot 15 may be spaced apart further than the remaining securing slots 14 so as to provides structural support near the first assembly slot 15. The second divider 12 provides a second assembly slot 16 extending from near a midpoint of the top edge 40 of the second divider 12 downwardly to approximately the centerline of the second divider 12. In certain embodiments, the second assembly slot 16 may be positioned and spaced where a securing slot 14 would otherwise be. The first and second assembly slots 15, 16 are dimensioned and adapted to interlock during assembly so that both bottom edges 38 of the first and second dividers 11, 12 operatively engage the supporting surface 60 or at least so that both the first and second bottom edges 38 are approximately coplanar. The first and second dividers 11, 12 may be removably arranged so as to intersect each other at various angles, enabling free-standing arrangements. Such arrangements define a general X-shaped organizer assembly 10, as illustrated in FIGS. 1 and 2.

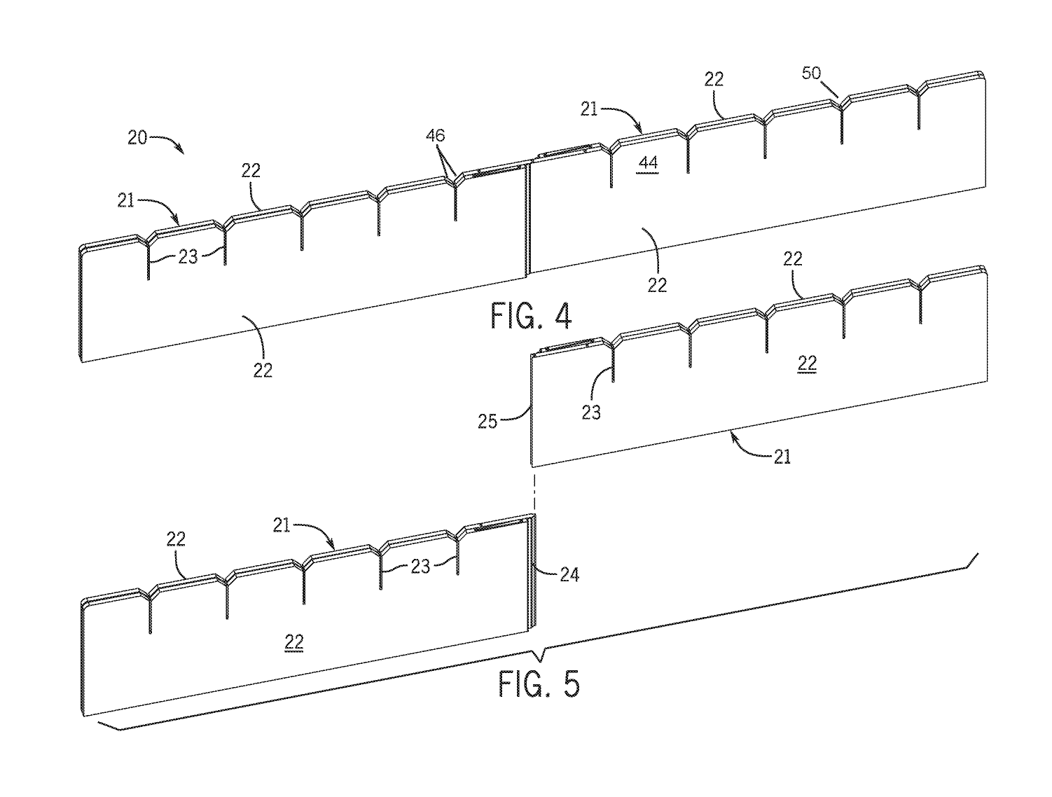

Referring to FIGS. 4 through 8, the organizer assembly may include at least one V-shaped divider 21, each V-shaped divider 21 having a body divider 22 and a wing divider 22A, each approximately coextensive. The wing divider 22A may be pivotally attached to the body divider 22 by a pivotal connector 26, so that the wing divider 22A may be moved between a collapsed configuration 20, as illustrated in FIG. 4 and an expanded configuration, as illustrated in FIG. 7. The collapsed configuration affording a flatter profile for storage purposes, while the expanded configuration affords more segregation of a working space and enabling free-standing arrangements. In certain embodiments, the expanded configuration includes at least a fifteen degree angle between the longitudinal axis of each of the first and second planar dividers. Each wing divider 22A may provide a latch arm 27 pivotally attached along the top edge 40 about a pivot pin 28. Each body divider 22 may provide a latch pin 29 along its top edge 40 for the latch arm 27 to removably engage to provide further stability in the expanded configuration.

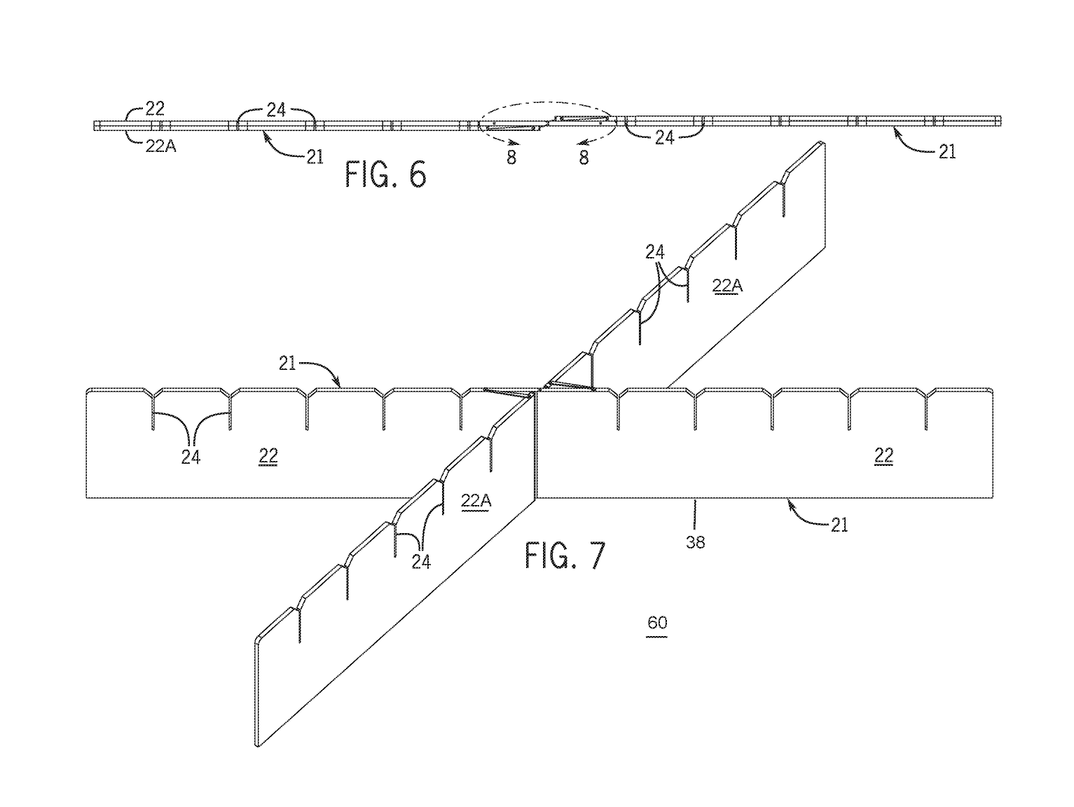

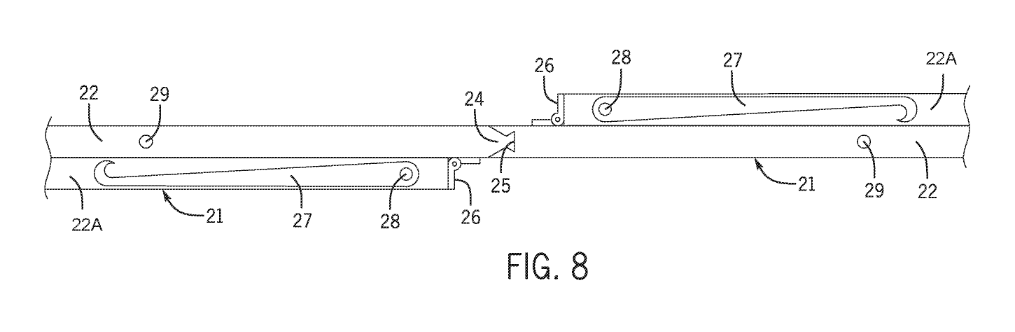

In certain embodiments, each body divider 22 may provide a male connector 24 and a female connector 25 on opposing ends of the body divider 22 so that a plurality of body dividers 22 may be sequentially removably mated, end-to-end, as illustrated in FIGS. 4 through 7, and in detail in FIG. 8, defining a general double V-shaped organizer assembly 10, as illustrated in FIGS. 6 and 7.

Each divider 11, 12, 31, 22, 22A may be made of material that can be repeatedly bent without fracturing, such as polyethylene, polypropylene, vinyl, nylon, various impregnated or laminated fibrous materials, various plasticized materials and the like. In certain embodiments, the dividers may extend for approximately four feet, have a height, the distance between the top and bottom edges 40, 39, of about eight inches, and a thickness of about 3/16^{th} of an inch, and thus planar.

Each divider 11, 12, 31, 22, 22A may have rounded corners so as to provide clearance in and not damage objects within their working spaces.

A method of using the present invention may include the following. The organizer assembly 10, 20, 30 disclosed above may be provided. A user may place the organizer assembly 10, 20 or 30 in a work space, such as the trunk of their car. Then the user may place any bags, for example grocery bags, in the securing slits 14, 23 or 35, in order to keep the bags from rolling around in your trunk, or having the contents of the bags spilling out. In certain embodiments, the handles of the bag may be slid through the lead-in notch 50 into the securing slits 14, 23 or 35.

The organizer assembly 10, 20 or 30 may also be used for segregating the bag types or groceries types, keeping heavy items from crushing fragile items, such as eggs, bread, and fruit. Furthermore, the organizer assemblies 10, 20 or 30 are also good for keeping other tall items from tipping over, while in transit (such as a gas can). The different embodiments 10, 20 and 30 facilitate use in different types of vehicles, such as the back of vans, trunk of a car, the rear of the bed of a pick truck, and the like.

It should be understood, of course, that the foregoing relates to exemplary embodiments of the invention and that modifications may be made without departing from the spirit and scope of the invention as set forth in the following claims.

What is claimed is:

1. An organizer assembly having interconnecting slotted partitions for segregating and organizing vehicular space for securing a plurality of containers therein, comprising:
a first planar divider defined by a first top edge and an opposing first bottom edge;
a plurality of first securing slots provided along the first top edge, wherein each first securing slot terminates between the first top edge and the first bottom edge; and
wherein each of the plurality of first securing slots provides a lead-in notch communicating to the first top edge.

2. The organizer assembly of claim 1, further comprising an elongated base connected along the first bottom edge of the first planar divider.

3. The organizer assembly of claim 2, further comprising a plurality of supporting elements pivotal connected to opposing ends of the elongated base.

4. The organizer assembly of claim 1, further comprising:
a first assembly slot formed perpendicular to the first bottom edge;
a second planar divider defined by a second top edge and an opposing second bottom edge; and
a second assembly slot formed perpendicular to the second top edge, wherein the first and second assembly slots are dimensioned and adapted to engage so that both the first and second bottom edges are approximately coplanar.

5. The organizer assembly of claim 4, wherein the second planar divider further comprises:
a plurality of second securing slots provided along the second top edge, wherein each second securing slot terminates between the second top edge and the second bottom edge; and
wherein each of the plurality of second securing slots provides a lead-in notch communicating to the second top edge.

6. The organizer assembly of claim 5, wherein the first and second assembly slots are adapted so that the first and second planar dividers are movable between a collapsed configuration and an expanded configuration.

7. The organizer assembly of claim 5, wherein the expanded configuration comprises at least a fifteen degree angle between the longitudinal axis of each of the first and second planar dividers.

8. The organizer assembly of claim 1, further comprising:
a second planar divider defined by a second top edge and an opposing second bottom edge; and
a pivotal connection pivotally connecting a second end of the second planar divider near a first end of the first planar divider.

9. The organizer assembly of claim 8, further comprising:
a male connector disposed along the first end; and
a female connector disposed alone a distal end of the first planar divider, wherein the first planar divider extends from the first end to the distal end.

10. The organizer assembly of claim 9, wherein the second planar divider further comprises:
a plurality of second securing slots provided along the second top edge, wherein each second securing slot terminates between the second top edge and the second bottom edge; and
wherein each of the plurality of second securing slots provides a lead-in notch communicating to the second top edge.

11. The organizer assembly of claim 10, further comprising:
a latch arm pivotably connected to the second top edge of the second planar divider; and
a latch pin connected to the first top edge of the first planar divider so that the latch arm can removably engage the latch pin.

12. The organizer assembly of claim 11, wherein each of the plurality of first and second securing slots extend to approximately a centerline of the first and second planar dividers, respectively.

13. The organizer assembly of claim 7, wherein each of the plurality of first and second securing slots extend to approximately a centerline of the first and second planar dividers, respectively.

14. The organizer assembly of claim 3, wherein each of the plurality of first and second securing slots extend to approximately a centerline of the first and second planar dividers, respectively.

15. The organizer assembly of claim 14, wherein the first and second assembly slots are disposed approximately at a midpoint along the first and second planar dividers, respectively.
